(19) United States
(12) Patent Application Publication
(10) Pub. No.: US 2011/0122030 A1
(43) Pub. Date: May 26, 2011

(54) RADIO DEVICE

(75) Inventors: Yuichiro Suzuki, Sendai-shi (JP); Hideo Nakanishi, Yokohama-shi (JP)

(73) Assignee: PANASONIC CORPORATION, Kadoma-shi, Osaka (JP)

(21) Appl. No.: 12/739,595

(22) PCT Filed: Oct. 23, 2007
(86) PCT No.: PCT/JP2007/070635

§ 371 Date: Apr. 23, 2010

(51) Int. Cl. H01Q 1/24

(52) U.S. Cl. 343/702

(57) ABSTRACT

A subject of the present invention is to provide a radio device which is capable of improving a deterioration of an antenna gain caused due to a spring portion in an external memory connector.

A conductive member (17) for grounding a spring portion (16) in an external memory connector (13) to a circuit board (11) is provided. Alternately, pawls (23) connected electrically to the spring portion (16) are provided to a conductive chassis (21) to ground the spring portion (16). As a result, the resonance of the spring portion (16) is not caused and thus a deterioration of an antenna gain caused due to the resonance is improved.

### TECHNICAL FIELD

The present invention relates to a radio device such as a mobile terminal, or the like and, more particularly, a radio device having an external memory connector to which an external memory can be fitted.

### BACKGROUND ART

The user of the recent mobile terminal has a great abundance of occasions to handle the data, for example, to save image data of a camera, save music data being downloaded from a site on a network, pick out the saved image data or music data by using an external memory that is detachably attached to the equipment main body, and the like.

In the external memory connector provided to the mobile terminal that is enabled to use the external memory, a card guiding mechanism for guiding the external memory is provided. This card guiding mechanism has a slide member, and a spring portion that urges the slide member in the direction opposite to the insertion direction of the external memory (see Patent Literature 1, for example).

FIG. 8 is a general view of an external memory connector in the prior art, and FIG. 9 is a general view of an inside of the same external memory connector. In FIG. 8 and FIG. 9, an external memory connector 50 contains a conductive chassis 51, an insulating housing 52, a plurality of terminals 53, a conductive spring portion 54, and a card detecting switch 55.

A plurality of terminals 53, the spring portion 54, and the card detecting switch 55 are contained in the housing 52. The spring portion 54 is provided to urge the slide member (not shown) in the direction opposite to the insertion direction of the external memory, as described above. The card detecting switch 55 detects the insertion of the external memory into the housing 52, and is constructed by two metal pieces 55a, 55b. The metal pieces 55a, 55b is brought into a closed state when the external memory is inserted into the housing 52, and is brought into an open state when the external memory is removed from the housing 52.
Patent Literature 1: JP-A-2007-027030

### DISCLOSURE OF THE INVENTION

### Problems that the Invention is to Solve

By the way, in the radio device such as the mobile terminal, or the like, which is equipped with the external memory connector, such a problem exists that an antenna gain is deteriorated due to the resonance of a spring portion in the external memory connector.

The present invention has been made in view of such circumstances, and aims to provide a radio device capable of improving a deterioration of an antenna gain caused due to a conductive spring portion in an external memory connector.

### Means for Solving the Problems

A radio device of the present invention, includes a circuit board; an antenna connected to the circuit board; an external memory connector connected to the circuit board; a conductive spring portion provided to the external memory connector to expand/contract in an insertion direction of an external memory; and a conductive member for grounding the spring portion to the circuit board.

According to the above configuration, the conductive spring portion in the external memory connector is grounded to the circuit board via the conductive member. Therefore, the resonance is not caused due to the transmitted radio wave, and thus a deterioration of the antenna gain can be improved.

Also, in the above radio device, a lumped-constant element is provided between the spring portion and the circuit board.

According to the above configuration, the lumped-constant element is employed. Therefore, the spring portion can be grounded in an ideal phase as the antenna

Also, a radio device of the present invention, includes a circuit board; an antenna connected to the circuit board; an external memory connector connected to the circuit board; a conductive spring portion provided to the external memory connector to expand/contract in an insertion direction of an external memory; and a conductive chassis provided to surround the circuit board, the antenna, the external memory connector, and the conductive spring portion, and grounded to the circuit board; wherein pawls that are connected electrically to the conductive spring portion are provided to the conductive chassis.

According to the above configuration, the spring portion in the external memory connector is grounded to the circuit board via the pawls of the conductive chassis. Therefore, the resonance is not caused due to the transmitted radio wave, and thus a deterioration of the antenna gain can be improved.

Also, a radio device of the present invention, includes a circuit board; an antenna connected to the circuit board; an external memory connector connected to the circuit board; a conductive spring portion provided to the external memory connector to expand/contract in an insertion direction of an external memory; and a conductive chassis provided to surround the circuit board, the antenna, the external memory connector, and the conductive spring portion, and grounded to the circuit board; wherein a conductive member that is connected electrically to the conductive spring portion is provided to the conductive chassis.

According to the above configuration, the spring portion in the external memory connector is grounded to the circuit board via the conductive member of the conductive chassis. Therefore, the resonance is not caused due to the transmitted radio wave, and thus a deterioration of the antenna gain can be improved.

### Advantage of the Invention

The radio device of the present invention can improve a deterioration of an antenna gain caused due to the conductive spring portion in the external memory connector.

### BRIEF DESCRIPTION OF THE DRAWINGS

FIG. 1 A perspective view showing a schematic configuration of a radio device according to Embodiment 1 of the present invention.

FIG. 2 A general view of an inside of an external memory connector in FIG. 1.

FIG. 3 A general view of a back surface side of the external memory connector in FIG. 1.

FIG. 4 A general view of an inside showing a case where a lumped-constant element is provided to the external memory connector in FIG. 1.

FIG. 5 A general view of an external memory connector of a radio device according to Embodiment 2 of the present invention.

FIG. 6 A general view of a back surface side of a chassis of the external memory connector in FIG. 4.

FIG. 7 A general view of a back surface side showing a case where a conductive member is provided to the chassis of the external memory connector in FIG. 4.

FIG. 8 A general view of an external memory connector in the prior art.

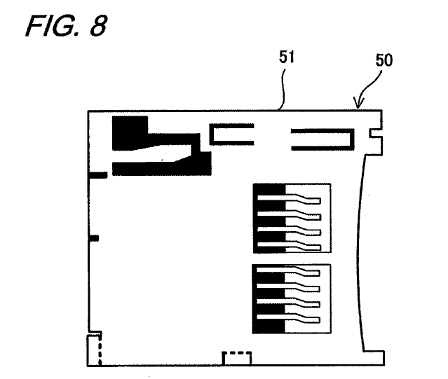

FIG. 9 A general view of an inside of the external memory connector in the prior art.

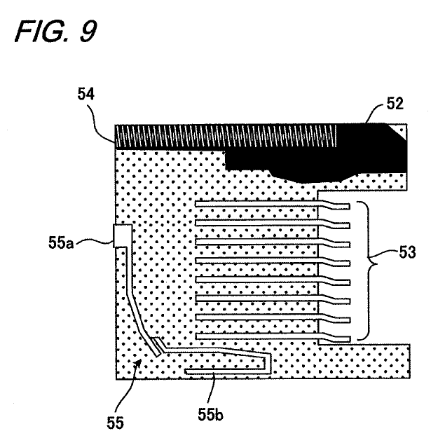

### DESCRIPTION OF REFERENCE NUMERALS

11 circuit board
12 planar inverted F-type antenna
13, 20 external memory connector
14 housing
15 terminal
16 spring portion
17 conductive member
18 card detecting switch
19, 22 hole
21 chassis
23 pawl
24 lumped-constant element
25 conductive member
30 card type memory

### BEST MODE FOR CARRYING OUT THE INVENTION

Preferred embodiments for carrying out the present invention will be explained in detail with reference to the drawings hereinafter.

### Embodiment 1

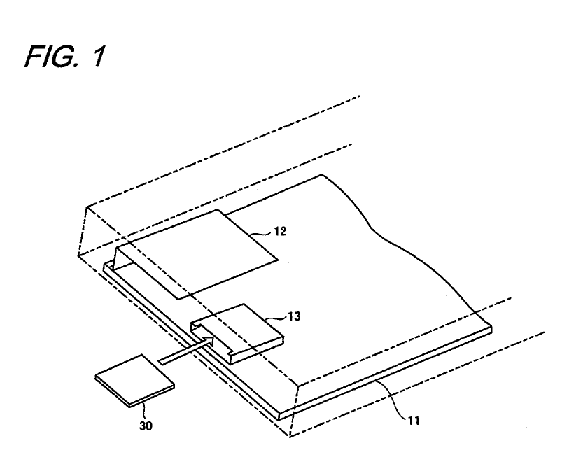

FIG. 1 is a perspective view showing a schematic configuration of a radio device according to Embodiment 1 of the present invention. In FIG. 1, the radio device according to the present embodiment includes a circuit board 11, a planar inverted F-type antenna 12 connected to the circuit board 11, and an external memory connector 13 connected to the circuit board 11. Here, various circuits such as a transmitting/receiving circuit, a sound processing circuit, etc., which are needed to function as the radio device, are installed into the circuit board 11. But their illustration will be omitted herein because these circuits are not directly relevant to the present invention.

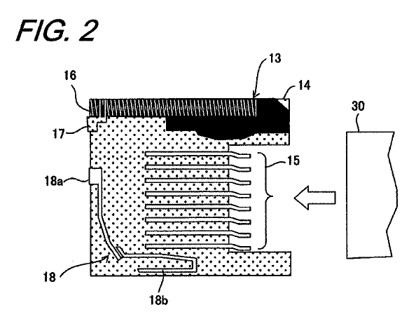

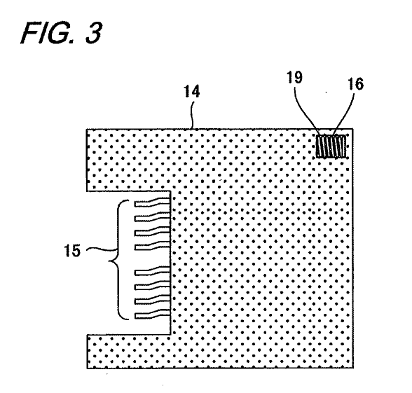

FIG. 2 is a general view of an inside of the external memory connector 13. Also, FIG. 3 is a general view of a back surface side of the external memory connector 13. In FIG. 2, the external memory connector 13 contains an insulating housing 14, a plurality of terminals 15, a conductive spring portion 16, a conductive member 17 for grounding the spring portion 16 to the circuit board 11, and a card detecting switch 18.

A plurality of terminals 15, the conductive spring portion 16, the conductive member 17, and the card detecting switch 18 are contained in the housing 14. The spring portion 16 is provided to urge a slide member (not shown) in the direction opposite to the insertion direction of a card type memory 30. The card detecting switch 18 detects the insertion of the card type memory 30 into the housing 14, and is constructed by two metal pieces 18a, 18b. The metal pieces 18a, 18b are brought into a closed state when the card type memory 30 is inserted into the housing 14, and are brought into an open state when the card type memory 30 is pulled out from the housing 14.

Also, as shown in FIG. 3, a hole 19 through which a part of the spring portion 16 (a portion that is positioned on the back side of the housing 14) is seen is provided in the housing 14. The conductive member 17 is formed into a shape that is fitted into this hole 19. When the conductive member 17 is fitted into the hole 19, the conductive member 17 is brought into contact with the spring portion 16 and also is grounded to the circuit board 11. Since the spring portion 16 is grounded, the resonance of the spring portion 16 is not caused and thus a deterioration of the antenna gain caused due to the resonance is improved.

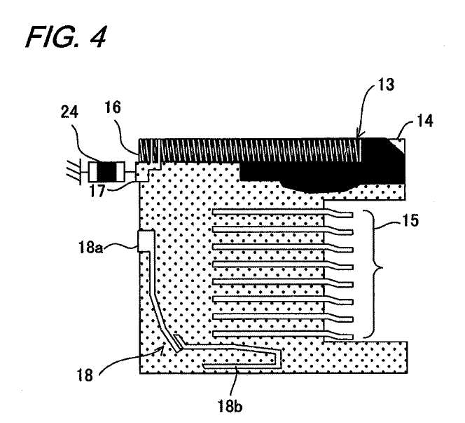

Here, as shown in FIG. 4, a lumped-constant element 24 such as a reactance element, a capacitance element, or the like as well as the conductive member 17 may be employed, and the spring portion 16 may be grounded via the lumped-constant element 24. In this case, when a value of the lumped-constant element 24 is decided to meet a desired frequency, the spring portion 16 can be grounded in an ideal phase as the antenna.

In this manner, in the radio device, the conductive member 17 for grounding the spring portion 16 in the external memory connector 13 to the circuit board 11 is provided. As a result, the resonance of the spring portion 16 is not caused and thus a deterioration of the antenna gain caused due to the resonance is improved.

### Embodiment 2

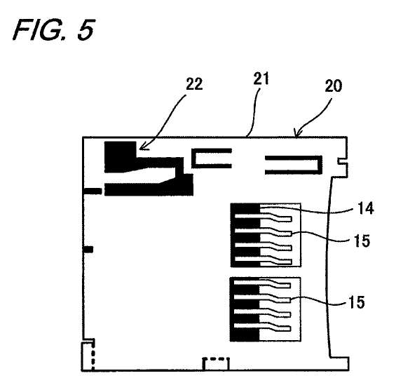

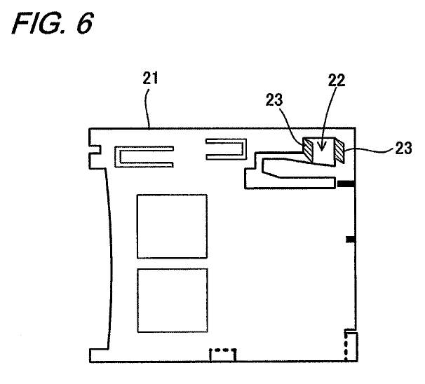

FIG. 5 is a general view of an external memory connector of a radio device according to Embodiment 2 of the present invention. Also, FIG. 6 is a general view of a back surface side of a chassis of the external memory connector. Here, except that a feature of the present embodiment resides in a chassis of the external memory connector, the radio device of the present embodiment has the similar configuration and structure to those of the radio device of Embodiment 1. Therefore, explanation will be made by affixing the same reference numerals to the common portions.

As shown in FIG. 5 and FIG. 6, an external memory connector 20 has a conductive chassis 21. In the conductive chassis 21, a hole 22 is provided by forming two foldable pawls 23 in the position where a part of the spring portion 16 (a portion that is positioned on the back side of the housing 14) is seen. Two pawls 23 are formed to form a right angle to the housing 14. Also, an interval between two pawls 23, i.e., a size of the hole 22, is set slightly smaller than a diameter of the spring portion 16 such that respective pawls 23 can grasp the spring portion 16. Since the conductive chassis 21 is grounded to the circuit board 11, the spring portion 16 is grounded to the circuit board 11 via the chassis 21 when two pawls 23 grasp the spring portion 16.

The spring portion 16 is grounded by two pawls 23 that are formed in the conductive chassis 21. Therefore, the resonance of the spring portion 16 is not caused and thus a deterioration of the antenna gain caused due to the resonance is improved.

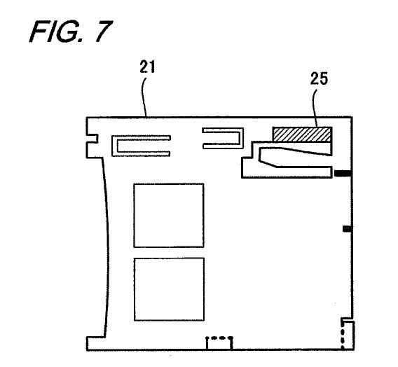

In this case, as shown in FIG. 7, except a formation of the pawls 23, a conductive member 25 such as a conductive cushion that is connected electrically to the spring portion 16, or the like may be provided to the conductive chassis 21.

In this manner, in the radio device of the present embodiment, the pawls 23 that are connected electrically to the conductive spring portion 16 are provided to the conductive chassis 21 such that the spring portion 16 may be grounded. As a result, the resonance of the spring portion 16 is not caused and thus a deterioration of the antenna gain caused due to the resonance is improved.

The present invention is explained in detail with reference to the particular embodiments as above. But it is obvious for those skilled in the art that various variations and modifications can be applied without departing from a spirit and a scope of the present invention.

### INDUSTRIAL APPLICABILITY

The present invention possesses such an advantage that a deterioration of the antenna gain caused due to the spring portion in the external memory connector can be improved, and is applicable to all radio devices such as the mobile terminal, and the like, which are used to hold a radio communication.

1. A radio device, comprising:
a circuit board;
an antenna connected to the circuit board;
an external memory connector connected to the circuit board;
a conductive spring portion provided to the external memory connector to expand/contract in an insertion direction of an external memory; and
a conductive member for grounding the spring portion to the circuit board.

2. A radio device according to claim 1, wherein a lumped-constant element is provided between the spring portion and the circuit board.

3. A radio device, comprising:
a circuit board;
an antenna connected to the circuit board;
an external memory connector connected to the circuit board;
a conductive spring portion provided to the external memory connector to expand/contract in an insertion direction of an external memory; and
a conductive chassis provided to surround the circuit board, the antenna, the external memory connector, and the conductive spring portion, and grounded to the circuit board;
wherein pawls that are connected electrically to the conductive spring portion are provided to the conductive chassis.

4. A radio device, comprising:
a circuit board;
an antenna connected to the circuit board;
an external memory connector connected to the circuit board;
a conductive spring portion provided to the external memory connector to expand/contract in an insertion direction of an external memory; and
a conductive chassis provided to surround the circuit board, the antenna, the external memory connector, and the conductive spring portion, and grounded to the circuit board;
wherein a conductive member that is connected electrically to the conductive spring portion is provided to the conductive chassis.
